(19) United States
(12) Patent Application Publication
(10) Pub. No.: US 2005/0253888 A1
(43) Pub. Date: Nov. 17, 2005

(54) Evaluating an image forming device

(76) Inventors: Robert Fogarty, San Diego, CA (US); Josep-Maria Serra, San Diego, CA (US); Robert F. Little, Escondido, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/844,279

(22) Filed: May 12, 2004

(51) Int. Cl. B41J 29/393

(52) U.S. Cl. 347/19

(57) ABSTRACT

A method for evaluating an image forming device includes forming an object on a print medium. A light beam is scanned along a scan line that intersects the object. Reflectance data corresponding to the scan line is obtained. The image forming device is evaluated according to the reflectance data.

### BACKGROUND

Ink printers can employ multiple pens, which eject drops of ink onto a page or sheet of print media. The pens can be fixed in an array spanning a width of the print media, or the pens may be mounted on a carriage, which is arranged to scan across a scan axis parallel to that width of the print media. The pens each include an array of nozzles that eject individual drops of ink on the print media. The drops collectively form a band or “swath” of an image, such as a picture, chart or text. As the print media is advanced, an image is incrementally printed. Manufacturing and other flaws can result in poorly aligned pens and nozzle misfires that ultimately degrade print quality.

### DESCRIPTION OF THE DRAWINGS

FIG. 1 is a perspective view of an exemplary pen.

FIGS. 2-5 are schematic views of an exemplary pen array.

FIG. 6 is a block diagram of an exemplary image forming device in which various embodiments of the present invention may be implemented.

FIG. 7 is a schematic illustration of a sheet of print media being urged past a pen and a scanner according to an embodiment of the present invention.

FIG. 8 is a block diagram illustrating logical program elements stored in device memory according to an embodiment of the present invention.

FIGS. 9-13 are exemplary flow diagrams illustrating methods according to various embodiments of the present invention.

FIG. 14 illustrates a triangle object used to evaluate a print medium velocity according to an embodiment of the present invention.

FIG. 15 illustrates an object formed by a pen in which the nozzles are firing properly according to an embodiment of the present invention.

FIG. 16 illustrates an object formed by a pen in which one or more nozzles have misfired according to an embodiment of the present invention.

FIG. 17 is a chart illustrating reflectance data for scan lines that intersect the objects of FIGS. 15 and 16 according to an embodiment of the present invention.

FIG. 18 illustrates an exemplary pattern of objects formed by an aligned array of pens according to an embodiment of the present invention.

FIG. 19 and 20 each illustrate an exemplary pattern of objects formed by a misaligned array of pens according to an embodiment of the present invention.

FIG. 21 illustrates an exemplary pattern of objects formed by an aligned array of pens according to an embodiment of the present invention.

FIGS. 22-25 each illustrate an exemplary pattern of objects formed by a misaligned array of pens according to an embodiment of the present invention.

FIG. 26 illustrates an object pattern formed by aligned pens according to an embodiment of the present invention.

FIG. 27 illustrates an object pattern formed by misaligned overlapping pens according to an embodiment of the present invention.

FIG. 28 illustrates an object pattern formed by misaligned underlapping pens according to an embodiment of the present invention.

FIG. 29 helps illustrate a method for identifying pen underlap and overlap according to an embodiment of the present invention.

FIG. 30 illustrates a scan line deviation caused by motion of the print media according to an embodiment of the present invention.

FIGS. 31 and 32 illustrate a deviation in object widths and distances between object pairs that results from a scan line deviation.

FIGS. 33A, 33B, 34A, and 34B help to illustrate a method for compensating for a scan line deviation caused by motion of the print media according to an embodiment of the present invention.

FIGS. 35-37 help illustrate a method for identifying rotational pen misalignment according to an embodiment of the present invention.

### DETAILED DESCRIPTION

### Introduction

It can be beneficial from to time to time to evaluate the operational status of an image forming device. Such evaluations can reveal beneficial information such as the velocity at which print media travels through the device. Where, an image forming device uses a pen, an evaluation can reveal misfiring nozzles. Where multiple pens, the alignment of those pens can be evaluated.

The following description is broken into sections. The first section, labeled “pen” describes the c omponents and function of an exemplary pen and helps to illustrates how a pen can be misaligned. The second section labeled “components,” describes an example of the physical and logical components that can be used to evaluate an image forming device. The third section, labeled “operation,” describes an exemplary series of method steps for evaluating an image forming device. The fourth section, labeled “examples,” describes various practical examples relating to calculating the velocity of a print medium, identifying misfiring nozzles, and evaluating pen alignment according to various embodiments of the present invention.

### Pen

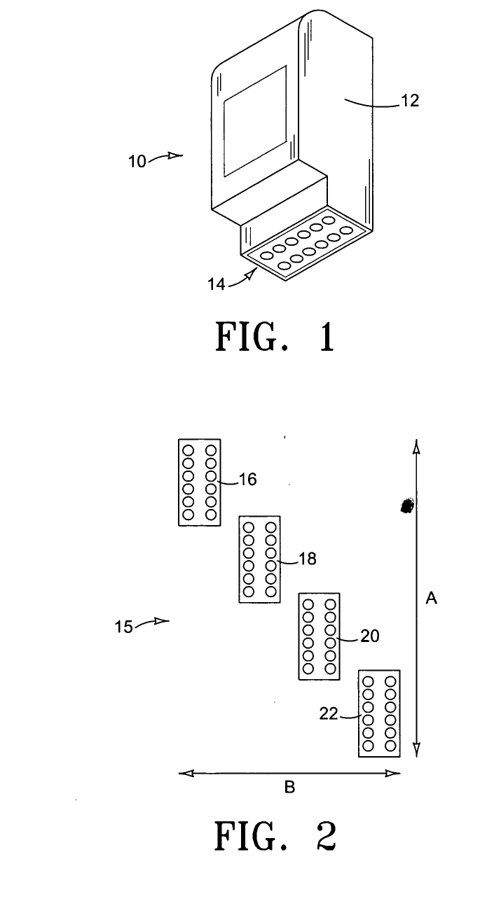

FIG. 1 illustrates an exemplary pen 10 that includes a reservoir 12 supplying ink to nozzles 14. Nozzles 14 are each responsible for ejecting ink from reservoir 12. When a given nozzle 14 becomes plugged or otherwise malfunctions, it misfires and can degrade print quality. An image forming device may employ any suitable number of such pens.

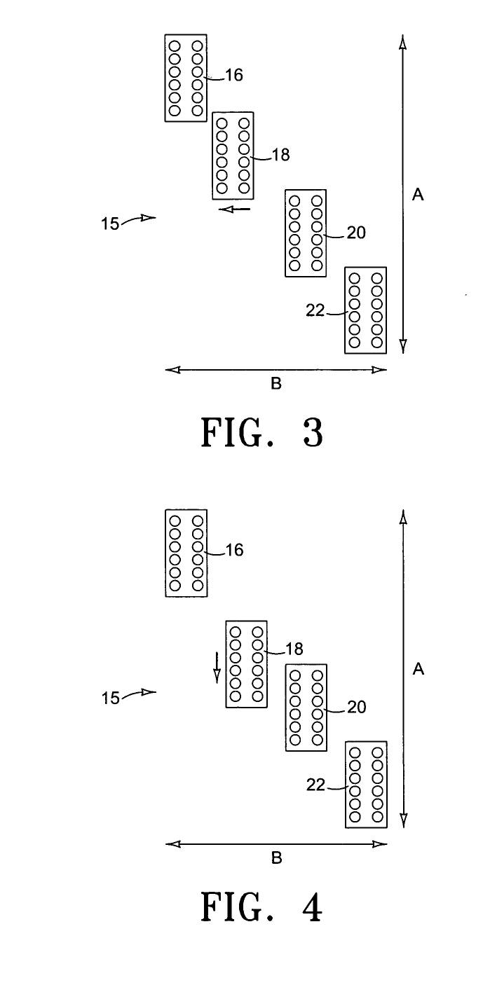

FIGS. 2-5 are simplified views of pen array 15 which is shown to include pens 16-22. While shown as including four pens 16-22 each having two columns of nozzles, a pen array might include any suitable number of pens with any suitable number of nozzle columns. Manufacturing and other flaws can misalign pens 16-22. In FIG. 2 for example, pens 16-22 are aligned. Line “B” in dicates an axis along which the paper travels, that is, the axis along which the sheet of print media is advanced through the image forming device relative to pens 16-22. Line “A” indicates an axis that is orthogonal to an axis along which the paper travels. Print quality can benefit when pens 16-22 are aligned relative to each other. One pen, pen 16 for example, can then be arbitrarily chosen as a reference. Alignment of the other pens 18-22 can then be determined relative to that reference pen.

In the examples of FIGS. 3-5, pen 16 has arbitrarily chosen as a reference pen. Other embodiments may use a different pen as a reference pen. In each of those figures, pen 18 is misaligned relative to reference pen 16. As can be seen in FIG. 3, pen 18 is misaligned along axis B. In FIG. 4, pen 18 is misaligned along axis A. In FIG. 5, pen 18 is misaligned in two-dimensions—along axis A and along axis B.

In each instance shown in FIGS. 3-5, if the image forming device does not compensate for the misalignment, print quality may be degraded by misregistration of the dots or pens under or overlapping each other. Before compensation can be made for a misalignment, it may be satisfactory to first identify the existence and then discern the nature of the misalignment—that is—whether the misalignment falls in axis B, axis A, or both.

### Components

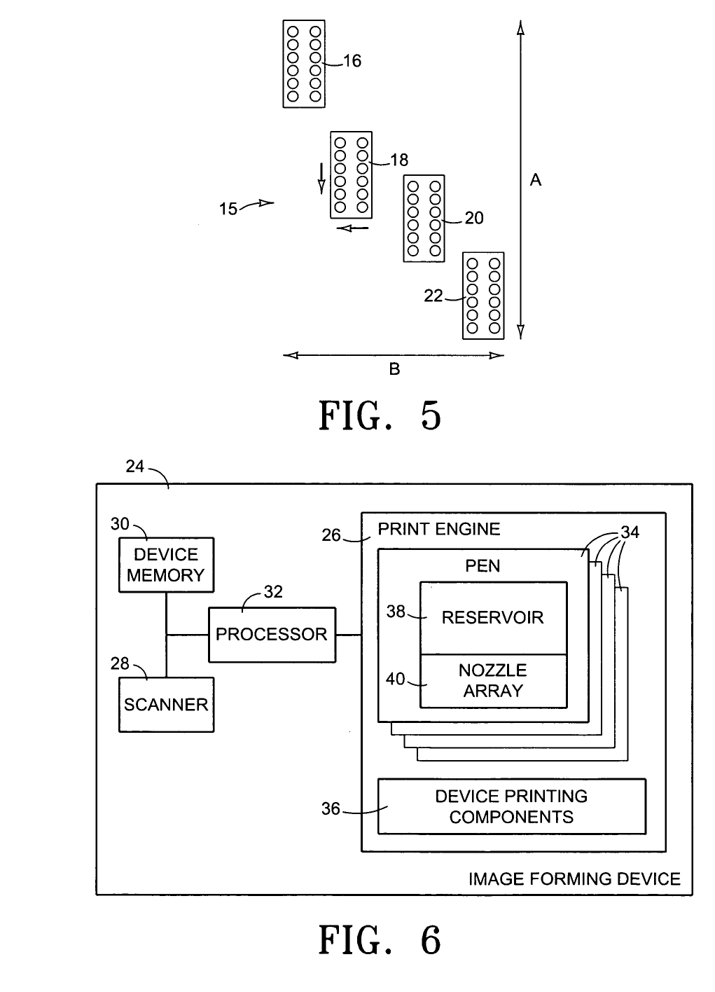

FIG. 6 illustrates an exemplary image forming device 24 in which various embodiments of the present invention may be implemented. Image forming device 24 represents a device capable of forming a desired image on a print medium such as paper. Image forming device 24 includes print engine 26, scanner 28, device memory 30, and processor 32. Print engine 26 represents generally the hardware components capable of forming an image on print media.

Scanner 28 represents generally any device capable of generating reflectance data for a given scan line. A laser bar code scanner is an example. In a laser scanning system, a laser light beam is directed by a lens or other optical components toward a target surface that includes a pattern such as a bar code. The scanner operates by scanning the light beam in a scan line across the pattern by means of motion of a scanning component, such as the light source itself or a rotating mirror disposed in the path of the light beam. The scanning component sweeps a beam spot across the surface tracing a scan line across the pattern.

Laser bar code scanners also include a sensor or photo detector which detects light reflected or scattered from the bar code along the scan line. The photo detector or sensor is positioned in the scanner in an optical path so that it has a field of view which ensures the capture of a portion of the light which is reflected or scattered off the pattern. This light is detected at consecutive points in time and converted into reflectance data. The reflectance data can be used to identify relative widths of “dark” po rtions (bars of a bar code) of the pattern and the relative distances between adjacent dark portions (distances between adjacent bars).

Device memory 30 represents generally any suitable computer readable medium capable of storing programs and/or data for controlling the operation of print engine 26. Processor 32 represents a processor capable of executing programs contained in device memory 30.

Print engine 26 is shown to include pens 34 and device printing components 36. Each pen 34 includes reservoir 38 and nozzles 40. While print engine 26 as shown include four pens 34, print engine 26 may include a single pen 34 or any other number of pens 34. In operation, nozzles 40 selectively ejects ink from reservoir 38 according to a desired print image. Device printing components 36 urge print media along a media path that passes through a print zone underneath nozzles 40 of each pen 34. As the print media passes through the print zone, one or more of the pens 34 forms a series of individual drops of ink on the print media. Once the print media has past through and out of the print zone, the series of drops disposed on the media collectively form an image, such as a picture, chart or text. It is noted that, in various embodiment, print engine 26 may instead employ electro-photographic techniques for forming an image.

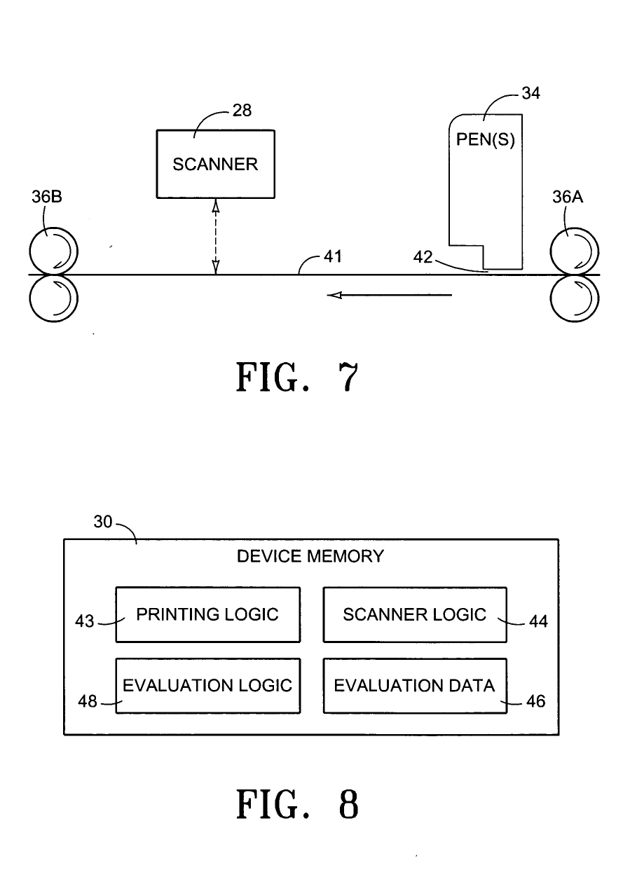

FIG. 7 is a partial schematic view of image forming device 24 shown in FIG. 6, according to an example embodiment. FIG. 7 illustrates an example of the relative positioning of pen 34 and scanner 28. Here, device printing components 36 (FIG. 6) include pinch rollers 36A and 36B that, when rotated, urge media sheet 41 along a media path through print zone 42 and past scanner 28. Scanner 28 is positioned downstream from pen 34 so that it can scan a line across a surface of media sheet 41.

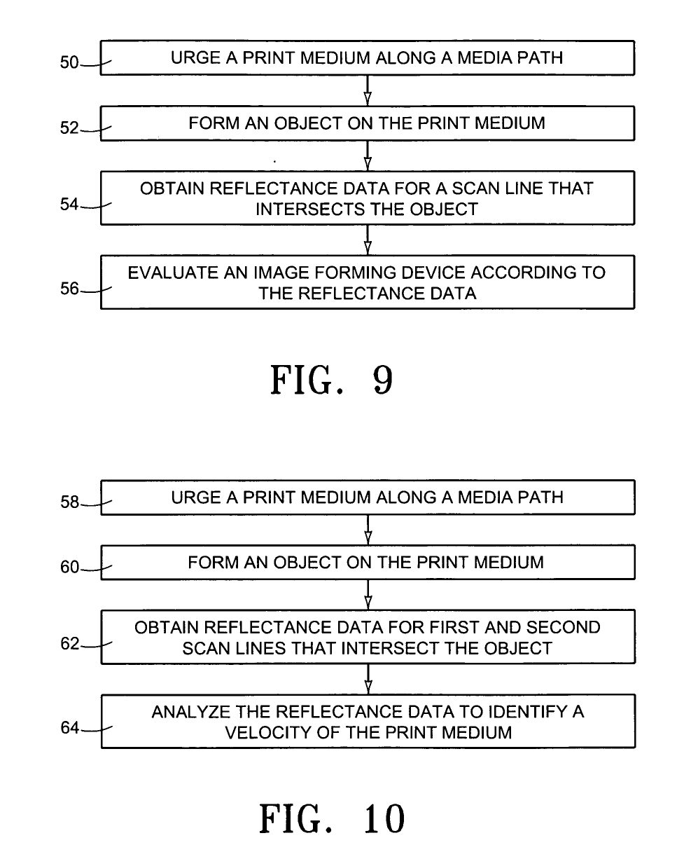

FIG. 8 is a block diagram illustrating contents of an example device memory 30. As shown, device memory 30 includes printing logic 43, scanner logic 44, evaluation data 46, and evaluation logic 48. Printing logic 43 represents generally any program or programs capable of directing print engine 26 (FIG. 6) to form an object pattern on print media. An object pattern is a pattern of two-dimensional objects where each object is formed, at least in part, by a different pen. Where a single pen is in use, an object pattern may then include a single object.

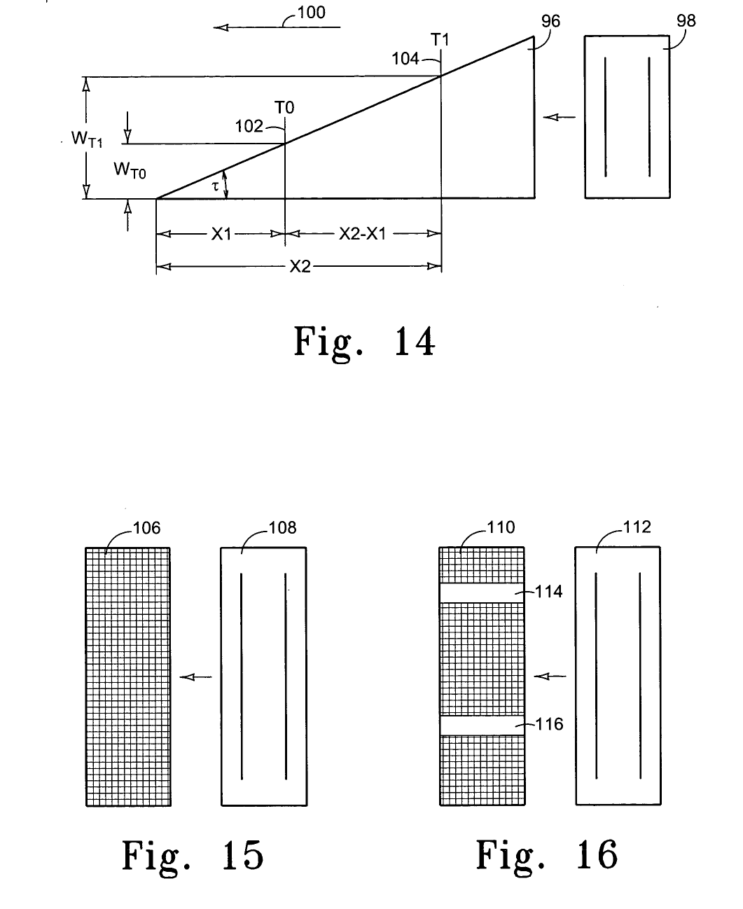

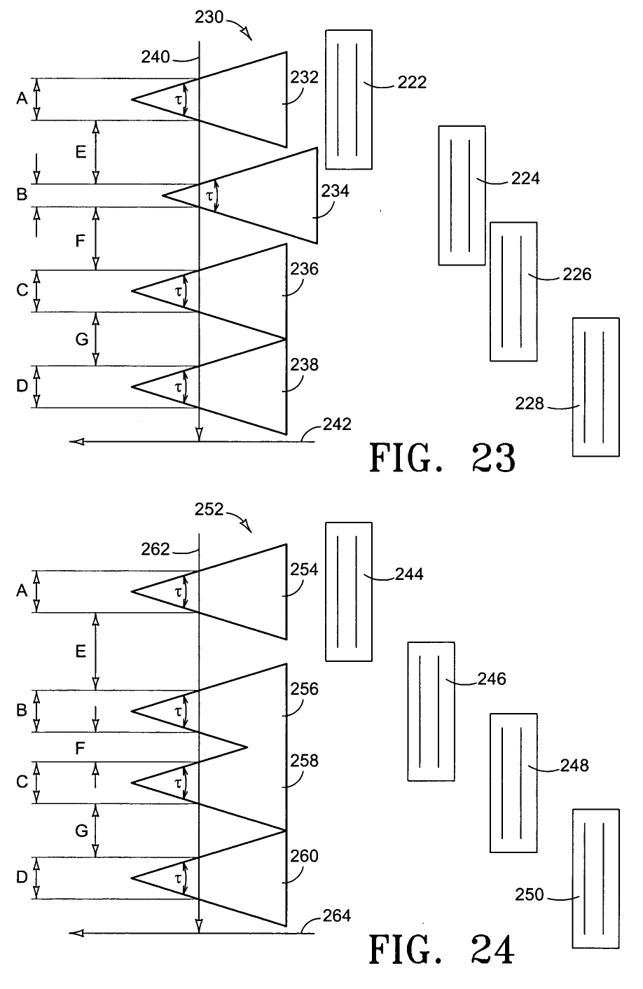

An object is any two-dimensional image having a discernable width along a line that intersects the image. In one implementation of the present invention, an object might be a rectangle as shown in FIGS. 15-20 below. In another implementation, an object might be a two-dimensional image formed so that it has a width dimension that uniquely varies along an axis that is parallel to the print media's direction of tr avel. In other words, the width of such an object at any given position along that axis is different that than the width of that object at all other positions along that axis—except where that width is zero, so that any width measurement corresponds to a unique location along the axis of motion. Patterns of such objects are illustrated in FIGS. 21-34 where each object is shown as an isosceles triangle, and the object pattern is a series of adjacent, uniform triangles. The exemplary isosceles triangle objects in FIGS. 21-34 satisfy this specific width constraint as would a multitude of other shapes—such as semicircles or parabolas for example.

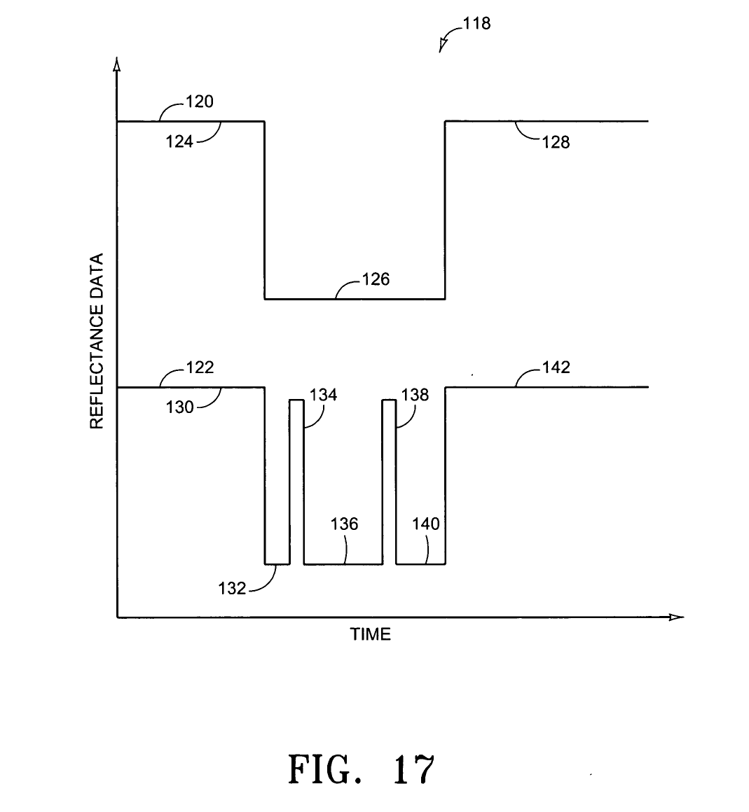

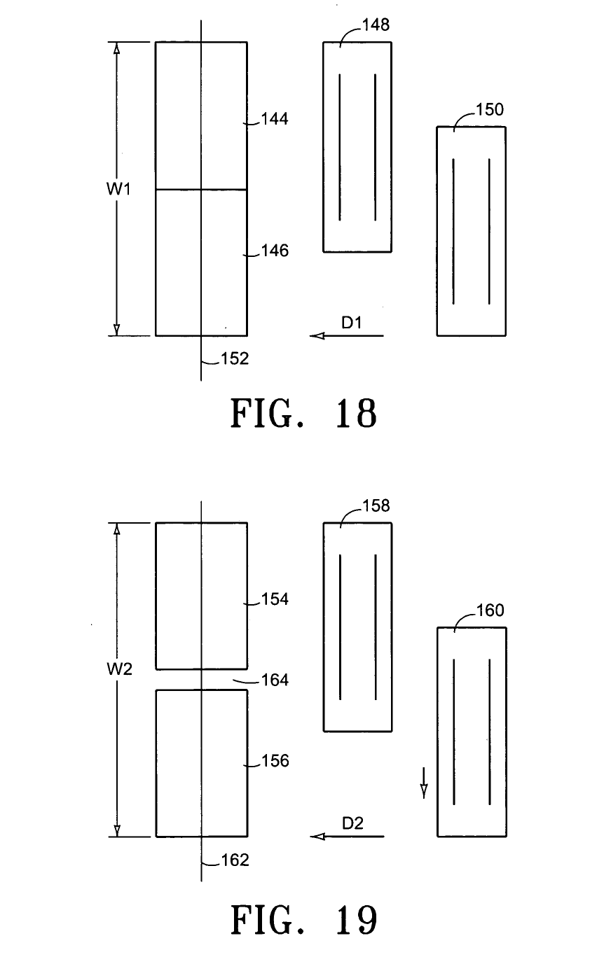

Scanner logic 44 represents generally any program or programs capable of directing scanner 28 to scan a light beam along a scan line that intersects each object of an object pattern and to generate reflectance data corresponding to the scan line. The reflectance data can be used as a measure of the relative widths of the objects along the scan line as well as a measure of the relative distances between adjacent objects. Reflectance data can also be used to identify an unexpected gap in an object. An object gap, described in more detail below with reference to FIGS. 16-17, can be any unexpected discontinuity in an object caused by a misfiring nozzle or nozzles. For example, where an object is intended to be a solid rectangle, an object gap might be a portion of the object that is not filled in. Reflectance data can be stored as evaluation data 46.

Evaluation logic 48 represents generally any program or programs capable analyzing reflectance data to evaluate image forming device 24 (FIG. 6). In one implementation, evaluation logic 48 might analyze reflectance data looking for object gaps caused by a misfiring nozzle or nozzles. In another implementation, evaluation logic 48 might analyze reflectance data to measure and compare the relative widths of the objects of a object pattern as well as the relative distances between adjacent pairs of objects of that object pattern to determine if the pens used to form each object are aligned. In doing so, evaluation logic 48 obtains and uses reflectance data generated by scanner logic 44.

As is discussed in more detail below, where evaluation logic 48 fails to find an object gap, it can conclude that the nozzles of the pen used to form that object are firing properly. Where evaluation logic 48 determines that the relative object widths are equal (within a predetermined tolerance) and the relative distances between each adjacent pair of objects match a calculated distance (within a predetermined tolerance), the pens used to form the objects are aligned. Differences beyond the predetermined tolerance indicate misalignment.

### Operation

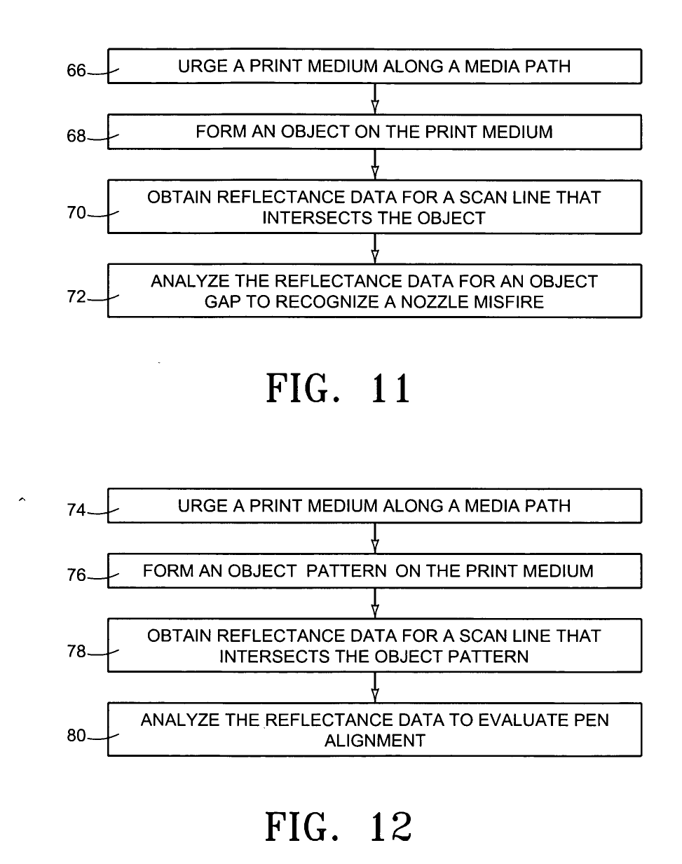

FIGS. 9-12 are exemplary flow diagrams each illustrating a series of exemplary method steps for evaluating an image forming device based on various embodiments for the invention. Specific examples of implementing those method steps are described in the subsequent section.

Starting with FIG. 9, a print medium is urged along a media path (step 50). An object is formed on the print medium (step 52). A light beam is scanned along a line that intersects the object so that reflectance data for the scan line can be obtained (step 54). An image forming device is evaluated according to the reflectance data (step 56). That evaluation, for example, can reveal a velocity at which the print medium travels through the image forming device. It can reveal misfiring nozzles. It can even reveal whether or not an array of pens is aligned.

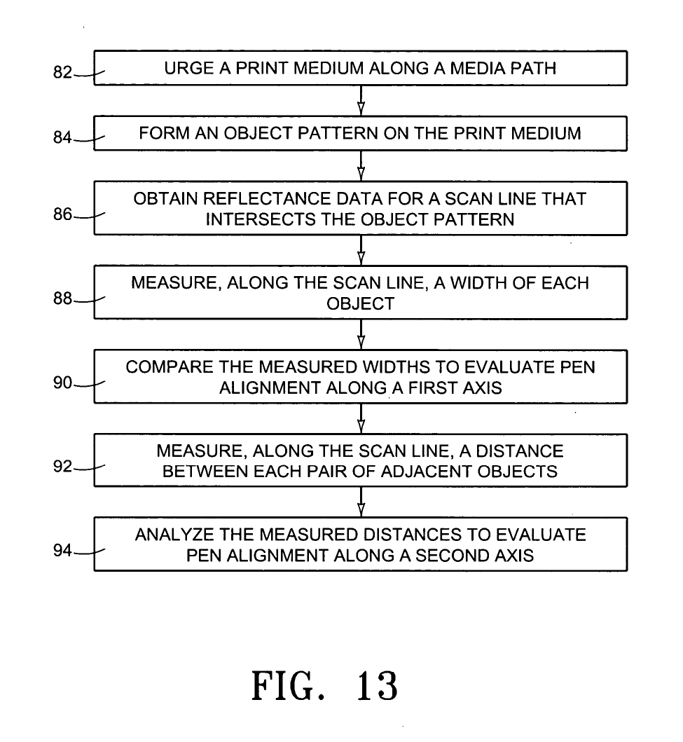

Moving to FIG. 10, method steps for identifying a velocity at which a print medium travels through an image forming device are described. An example of an implementation of the steps illustrated in FIG. 10 is provided below with reference to FIG. 14. Initially, a print medium is urged along a media path (step 58). An object is formed on the print medium (step 60). The object is formed such that it has a width dimension that varies in a predictable fashion along an axis that is parallel to the print medium's direction of tra vel. Reflectance data for first and second scan lines that intersect the object at two different times are obtained (step 62). The reflectance data obtained for the first scan line corresponds to a first point in time, while the reflectance data obtained for the second scan line corresponds to a second point in time. The reflectance data for the scan lines are analyzed to identify a velocity of the print medium (step 64). As an example, step 64 can involve measuring the width of the object along the first scan line and along the second scan line. As is shown below with reference to FIG. 14, a calculation based on the measured widths, the time elapsed between when the reflectance data was obtained for the first and second scan lines in step 62, and one or more geometric features of the object formed in step 60 can reveal a velocity of the print medium.

Referring now to FIG. 11, method steps for recognizing a nozzle misfire are described. An example of an implementation of the steps illustrated in FIG. 11 is provided below with reference to FIGS. 15-17. Initially, a print medium is urged along a media path (step 66). An object is formed on the print medium (step 68). A light beam is scanned along a line that intersects the object so that reflectance data for the scan line can be obtained (step 70). The reflectance data is analyzed (step 72). The presence of an object gap in the reflectance data represents a nozzle misfire. An object gap can be identified by an unexpected pulse in the reflectance data was is shown with reference to FIGS. 16 and 17 below. An object gap can also be identified by comparing a measured width of an object to an expected width. Where the misfiring nozzle causes the object to be truncated, the measured width may differ from an expected width. Where that difference exceeds a predetermined tolerance, one can presume that an object gap exists on one or both ends of the particular object.

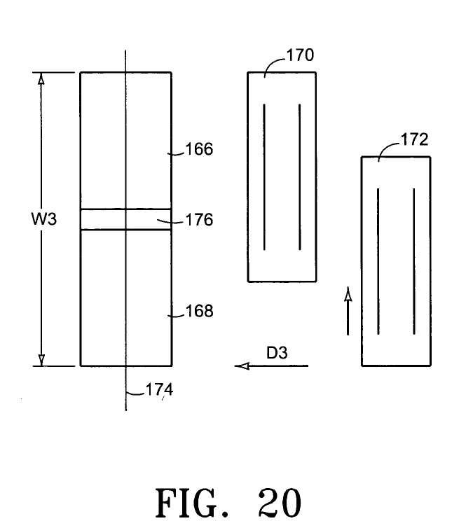

Shifting to FIG. 12, method steps for evaluating pen alignment along a single axis are described. Various examples of implementations of the steps illustrated in FIG. 12 are provided below with reference to FIGS. 18-20. Initially, a print medium is urged along a media path (step 74). An object pattern is formed on the print medium (step 76). Each object in the pattern is formed, at least in part, by a different pen. A light beam is scanned along a line that intersects the object pattern so that reflectance data for the scan line obtained (step 78). The reflectance data is analyzed to evaluate pen alignment (step 80). Step 80, for example, can involve analyzing the reflectance data to identify an underlap or overlap between adjacent objects in the object pattern. As is shown with reference to FIGS. 18-20, either condition can be caused by pen misalignment.

Moving to FIG. 13, method steps for evaluating pen alignment along orthogonal axes are described. Various examples of implementations of the steps illustrated in FIG. 13 are provided below with reference to FIGS. 21-34. Initially, a print medium is urged along a media path (step 82). An object pattern is formed on the print medium (step 84). Each object is formed at least in part by a different pen and each object has a width dimension that varies uniquely according to that object's position alon g a first axis that is parallel to a direction of travel of the print medium. A light beam is scanned along a line that intersects the object pattern so that reflectance data for the scan can be obtained (step 86).

The reflectance data is analyzed to measure a width of each object along the scan line (step 88). The object widths measured in step 88 are compared to determine if the pens are aligned along a first axis (step 90). The first axis is parallel to the print media's direction of trav el. Where the comparison of the measured object widths in step 88 reveals that those object widths are equal within a predetermined tolerance, one can conclude that the pens used to form those objects are aligned along the first axis. Where one or more measured widths differ from the others by a value exceeding the predetermined tolerance, one or more of the pens are misaligned. The extent to which a pen is misaligned along the first axis can be quantified by the difference between a measured width of an object formed by that pen and a measured width of an object formed by a reference pen presumed to be aligned. A positive valued difference indicates misalignment in one direction along the first axis while a negative valued difference indicates misalignment in an opposite direction.

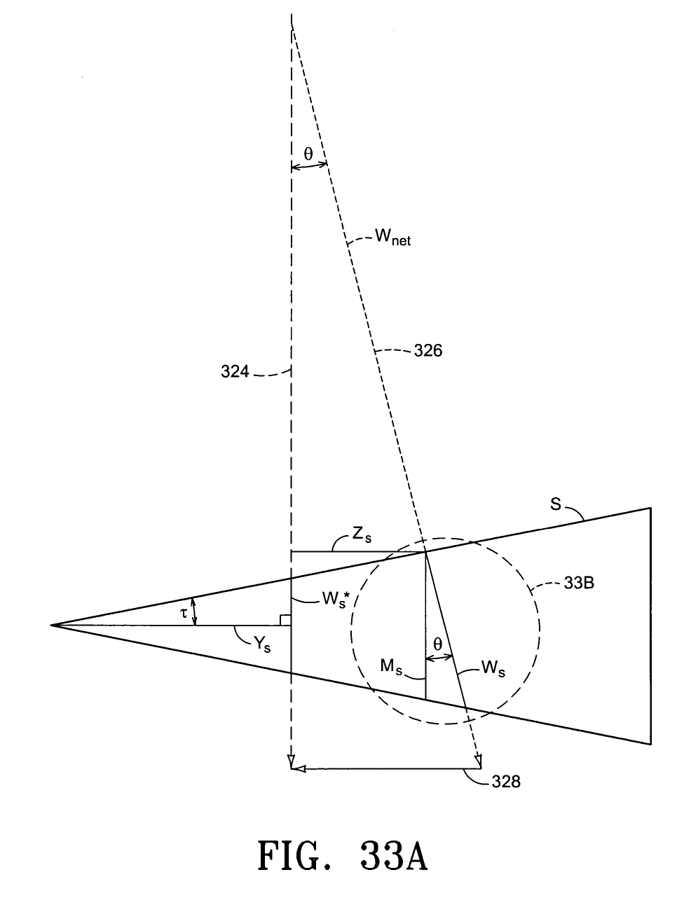

The reflectance data is analyzed to measure a distance between each pair of adjacent objects along the scan line (step 92). The distances measured in step 92 are analyzed to determine if the pens are aligned along a second axis (step 94). The second axis is orthogonal to the first axis. Analyzing distances in step 94, for example, can involve calculating a distance between adjacent objects. A calculated distance is the distance between adjacent object pairs formed by pens that are aligned along the second axis. As is discussed below with reference to FIG. 29, the calculated distance can be ascertained as a function of the measured width of an object. Each measured distance between adjacent object pairs can be compared to the calculated distance. Differences beyond a predetermined tolerance indicate that one or more of the pens are misaligned along the second axis. The extent to which a pen is misaligned along the second axis can be quantified by the difference between the measured distance and the calculated distance. A positive valued difference indicates misalignment in one direction along the first axis while a negative valued difference indicates misalignment in an opposite direction.

### EXAMPLES

FIGS. 14-34 provide examples implementing the method steps illustrated in FIGS. 9-13. FIG. 14 helps to illustrate how a velocity of a print medium might be calculated, according to an example embodiment. Object 96 has been formed by pen 98. Arrow 100 indicates the direction the print medium is traveling. Object 96 is a right triangle with a known angle (τ) Line 102 represents a scan line for which reflectance data is obtained at a time (T0). Line 104 represents a scan line for which reflectance data is obtained at a time (T1). Analyzing the reflectance data can reveal width (W_{T0}), the width of object 96 along scan line 102, and (W_{T1}), the width of object 96 along scan line 104.

The distances (X1) and (X2) can be calculated as functions of (W_{T0}) and (W_{T1}) respectively.
X1=W_{T0}/Tan(τ);
X2=W_{T1}/Tan(τ); so
X2−X1=(W_{T1}−W_{T0})/Tan(τ).
The print medium on which object 96 is formed traveled a distance of (X2−X1) in the time frame (T1−T0). The velocity (V) of the print media along direction arrow 100 can be calculated as V=(W_{T1}−W_{T0})/(T1−T0)Tan(τ).

FIGS. 15-17 help to illustrate how a misfiring nozzle or nozzles are identified according to an example embodiment. Starting with FIG. 15, object 106 has been formed by pen 108. As can be seen, object 106 is a solid rectangle indicating that pen 108 does not have any misfiring nozzles. Moving to FIG. 16, object 110 has been formed by pen 112. Object 110 has gaps 114 and 116 caused by misfiring nozzles of pen 112.

FIG. 17 charts reflectance data 120 and 122 taken along scan lines that intersect object 106 (FIG. 15) and object 110 (FIG. 16) respectively. Reflectance data 120 and 122 are charted as functions of time. Reflectance data 120 starts at a higher value 124, drops to a lower value 126, and returns to a maximum value 128. Lower value represents the presence of object 106 in a scan line. Reflectance data 122 starts at a higher value 130, drops to a lower value 132, pulses at 134, returns to the lower 136, pulses at 138, returns to the lower 140 and finally returns to a higher value 142. Lower values 132, 136, and 140 represents the presence of object 110 in a scan line. Pulses 134 and 138 represent object gaps 114 and 116.

The presence of pulses 134 and 138 in reflectance data 122 indicates that pen 112 (FIG. 16) has misfiring nozzles causing object gaps 114 and 116. The absence of pulses in reflectance data 120 indicates that the nozzles of pen 108 (FIG. 15) are firing properly.

FIGS. 18-20 help to illustrate how pen alignment along a single axis might be evaluated. Starting with FIG. 18, objects 144 and 146 have been formed by pens 148 and 150. Scan line 152 intersects objects 144 and 146. Arrow (D1) represents the direction of travel of the print medium on which objects 144 and 146 are formed. An analysis of reflectance data taken along scan line 152 will reveal that there is no gap between objects 144 and 146. The analysis will also reveal that objects 144 and 146 have a combined width (W1). Assuming that (W1) is within a predetermined tolerance of an expected combined width, one can presume that pens 158 and 160 are aligned along an axis perpendicular to the print medium's direction of travel (D1).

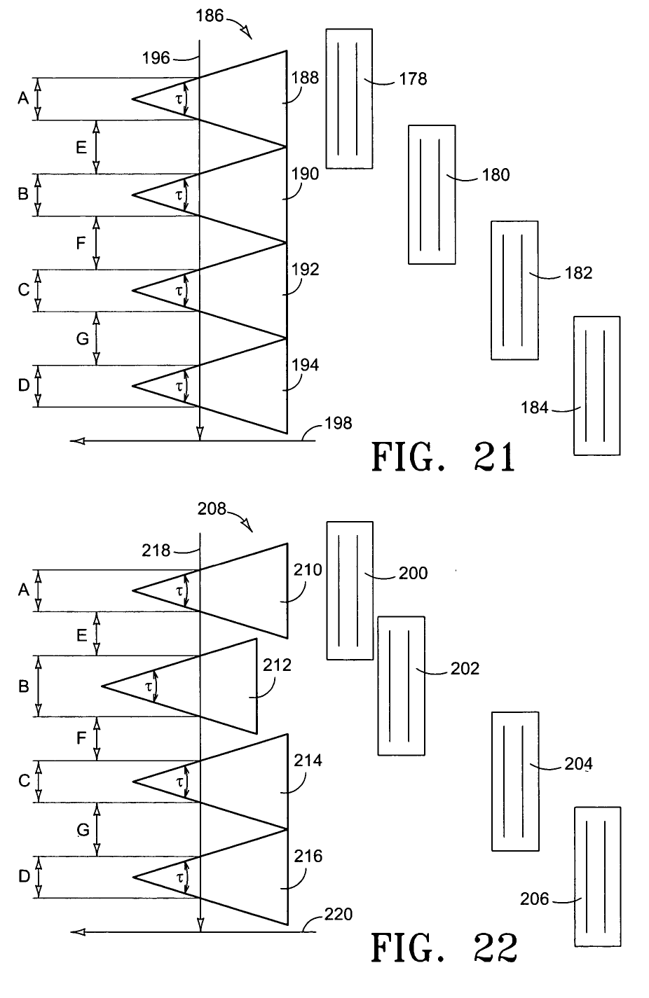

Moving to FIG. 19, objects 154 and 156 have been formed by pens 158 and 160. Scan line 162 intersects objects 154 and 156. Arrow (D2) represents the direction of travel of the print medium on which objects 154 and 156 are formed. An analysis of reflectance data taken along scan line 162 will reveal that there is a gap 164 between objects 154 and 156. In other words, objects 154 and 156 underlap one another—an indication that one of pens 170 and 172 is misaligned. If, for example pen 170 is selected as a reference pen and presumed to be aligned, then pen 172 would be determined to be misaligned along an axis orthogonal to (D2). The extent of the misalignment can be quantified by analyzing the reflectance data to measure (W2)—the combined widths of objects 154 and 156 including gap 164. The extent to which (W2) exceeds an expected width is the extent to which pen 160 is misaligned. The extent to which (W2) exceeds the expected width is also a measure of an underlap resulting from gap 164.

Referring now to FIG. 20, objects 166 and 168 have been formed by pens 170 and 172. Scan line 174 intersects objects 166 and 168. Arrow (D3) represents the direction of travel of the print medium on which objects 166 and 168 are formed. An analysis of reflectance data taken along scan line 162 will reveal that there is no gap between objects 166 and 168 and that objects 166 and 168 have a combined width (W3). Where an expected combined width exceeds (W3) beyond a predetermined tolerance, one can presume that an overlap 176 exists between objects 166 and 168. The existence of overlap 176 indicates a misalignment. If, for example pen 170 is selected as a reference pen and presumed to be aligned, then pen 172 would be determined to be misaligned along an axis orthogonal to (D2). The extent of the misalignment can be quantified by the extent to which the expected combined width of objects 166 and 168 exceeds (W3). Such is a measure of overlap 176.

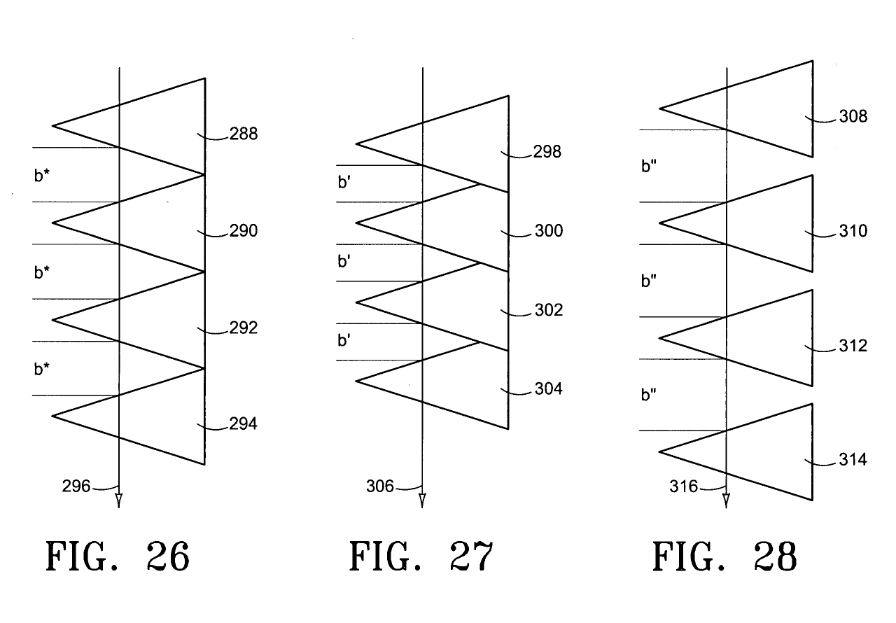

FIGS. 21-34 illustrate how pen alignment along orthogonal axes is evaluated according to an example embodiment. FIGS. 21-25 each illustrate an exemplary pattern of printed objects formed by an array of staggered pens and help illustrate steps taken to identify pen misalignment along a first axis parallel to the print media direction of travel. FIGS. 26-29 help illustrate steps taken to identify pen misalignment along a second axis orthogonal to the first axis.

Referring first to FIG. 21, pens 178-184 have formed object pattern 186 on print media. Each object 188-194 of pattern 186 is an isosceles triangle formed by a different pen 178-184, respectively. Each triangle object has a known angle (τ). Direction arrow 196 represents a scan line from which reflectance data is obtained. Direction arrow 198 represents the print media's direction of trav el. The widths of objects 188-194 vary depending upon the position of scan line 196. Should scan line 196 be moved toward pens 178-184, the widths will increase. Should scan line 196 be moved away from pens 178-184, the widths will decrease.

The variables A, B, C, and D represent the respective measured widths of objects 188-194 taken along scan line 196. A cursory inspection reveals that A=B=C=D. One can conclude then that pens 178-184 are aligned along a first axis that is parallel to the print media's di rection of travel 198.

The variables E, F, and G represent the measured distances between pairs of adjacent objects. E represents the measured distance between adjacent object pair 188, 190. F represents the measured distance between adjacent object pair 190, 192. G represents the measured distance between adjacent object pair 192, 194. Further calculations, examples of which are described below with reference to FIGS. 26-29, can be made to determine whether pens 178-184 are in fact aligned along the second axis.

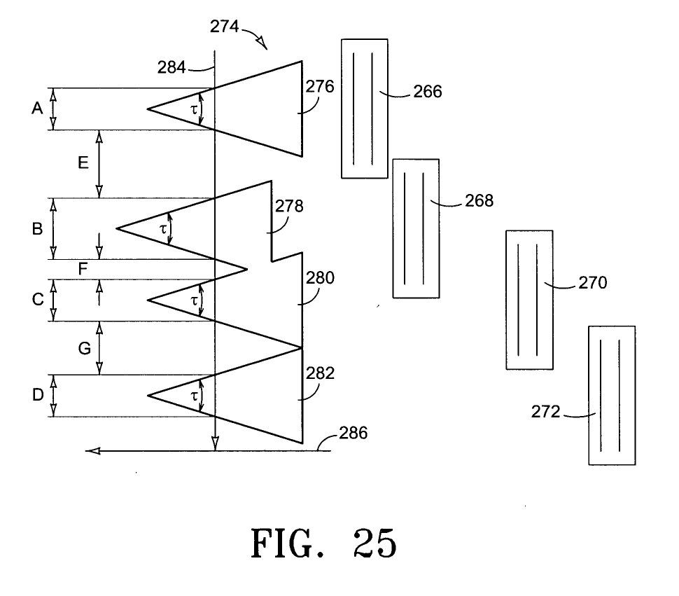

Referring now to FIG. 22, pens 200-206 have formed object pattern 208 on print media. Each object 210-216 of pattern 208 is a triangle formed by a different pen 200-206, respectively. Direction arrow 218 represents a scan line from which reflectance data is obtained. Direction arrow 220 represents the print media's direction of travel. The variables A, B, C, and D represent the respective measured widths of objects 210-216 taken along scan line 218. A cursory inspection reveals that A=C=D, but B>A, C, and D. One can conclude then that pens 200, 204, and 206 are aligned along a first axis that is parallel to the print media's direction of travel 220. However, pen 202, the pen that formed object 212, is misaligned along the first axis. Because the value of B exceeds that of A, C, and D, one can conclude that pen 202 prematurely formed object 212 because pen 202 is misaligned downstream along the first axis. The extent of the misalignment can be quantified by (B-A)/(2Tan(τ/2)). A statement of equality, such as A=C, means that any difference is less than a predetermined tolerance. A statement of inequality, such as B>A, means that the difference exceeds the predetermined tolerance.

Referring now to FIG. 23, pens 222-228 have formed object pattern 230 on print media. Each object 232-238 of pattern 230 is a triangle formed by a different pen 222-228, respectively. Direction arrow 240 represents a scan line from which reflectance data is obtained. Direction arrow 242 represents the print media's direction of travel. The variables A, B, C, and D represent the respective measured widths of objects 232-238 taken along scan line 240. A cursory inspection reveals that A=C=D, but B<A, B, and C. One can conclude then that pens 222, 226, and 228 are aligned along a first axis that is parallel to the print media's direction of travel 242. However, pen 224, the pen that formed object 234, is misaligned along the first axis. Because the value of B is less than that of A, C, and D, one can conclude that pen 224 formed object 234 too late because pen 224 is misaligned upstream along the first axis The extent of the misalignment can be quantified by (B-A)/(2Tan(τ/2)).

Referring now to FIG. 24, pens 244-250 have formed object pattern 252 on print media. Each object 254-260 of pattern 252 is a triangle formed by a different pen 244-250, respectively. Direction arrow 262 represents a scan line from which reflectance data is obtained. Direction arrow 264 represents the print media's direction of travel. The variables A, B, C, and D represent the respective measured widths of objects 254-260 taken along scan line 262. A cursory inspection reveals that A=B=C=D. One can conclude then that pens 244-250 are aligned along a first axis that is parallel to the print media's direction of travel 264.

Referring now to FIG. 25, pens 266-272 have formed object pattern 274 on print media. Each object 276-282 of pattern 274 is a triangle formed by a different pen 266-272, respectively. Direction arrow 284 represents a scan line from which reflectance data is obtained. Direction arrow 286 represents the print media's direction of travel. The variables A, B, C, and D represent the respective measured widths of objects 276-282 taken along scan line 284. A cursory inspection reveals that A=C=D, but B>A, C, and D. One can conclude then that pens 276, 280, and 282 are aligned along a first axis that is parallel to the print media's direction of travel 286. However, pen 268, the pen that formed object 278, is misaligned along the first axis. Because the value of B exceeds that of A, C, and D, one can conclude that pen 268 prematurely formed object 278 because pen 268 is misaligned downstream along the first axis. The extent of the misalignment can be quantified by (B-A)/(2Tan(τ/2)).

FIGS. 26-29 help illustrate how to identify pen misalignment along the second axis. As noted above, a calculated distance between an object pair is calculated and then compared to the measured distances between adjacent object pairs. As will be discussed below with reference to FIG. 29, the calculated distance can be calculated as a function of a measured object width. Misalignment exists where a measured distance differs from the calculated distance beyond a predetermined tolerance.

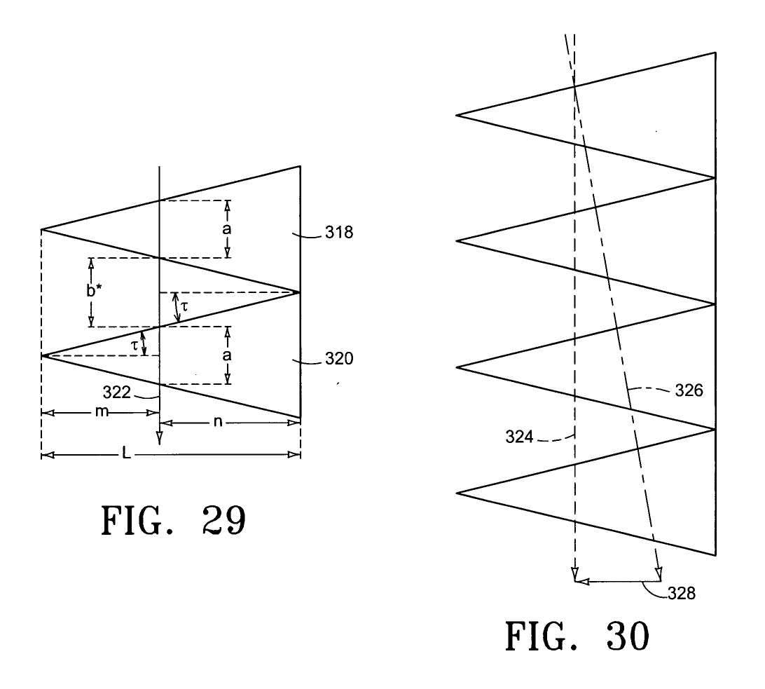

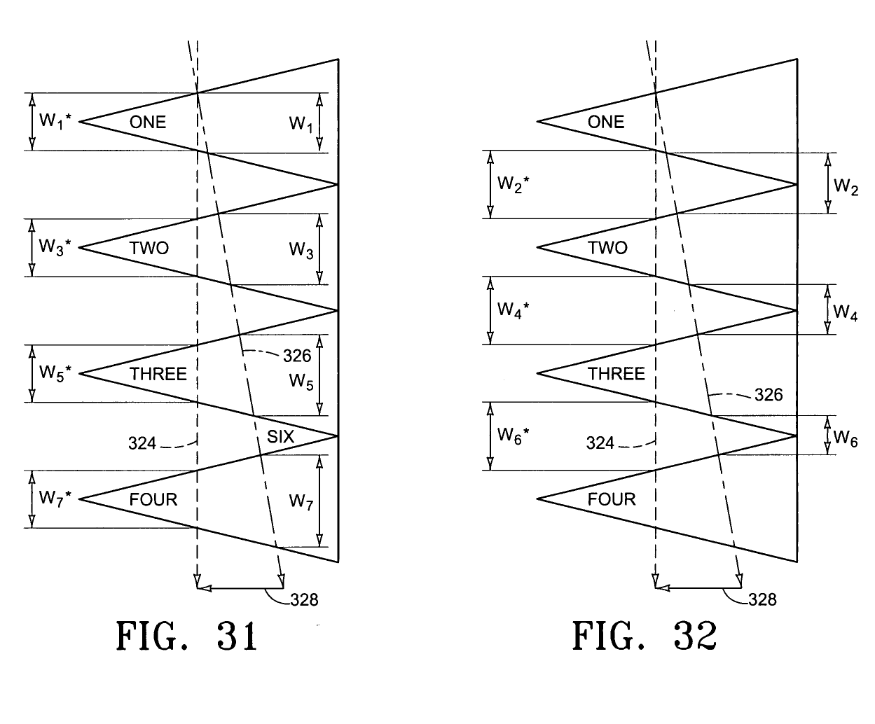

It is also noted that where the measured distances between objects on a scan line are determined to be equal within a predetermined tolerance, it can be presumed that the pens responsible for forming those objects are at least equally spaced along the second axis. Equal spacing, however, is not a conclusive indication that the pens are aligned along that axis. Equal spacing is just as likely to indicate that the pens overlap or underlap one another. In FIG. 26, objects 288-294 are equally spaced along axis 296. Objects 288-294 are also aligned along that axis. In FIG. 27, objects 298-304 are equally spaced along axis 306. However, objects 298-304 are misaligned relative to object 298 causing adjacent object pairs to overlap one another. In FIG. 28, objects 308-314 are equally spaced along axis 316. However, objects 308-314 are misaligned relative to object 308 causing adjacent object pairs to underlap one another.

FIG. 29 helps illustrate calculations that can be made to identify pen misalignment along an axis orthogonal to the direction of travel of the print media—referred above as the second axis. FIG. 29 illustrates two adjacent objects 318 and 320 formed by such pens. The value of (a) represents the measured width of objects 318 and 320 along scan line 322. The measured distance between objects 318 and 320 along scan line 322 is also known and is referred to as (b). The variable (b*) represents the calculated distance between objects 318 and 320 along scan line 322. The value of (b*) may or may not be the actual distance (b) between objects 318 and 320.

The goal is to calculate the value for (b*) and compare that calculated value to the measured value (b). Still referring to FIG. 29, the value of (L) is a known design parameter of objects 318 and 320, so is the value of the angle (τ). From the known values, values for variables (m) and (n) can be discerned as follows:
m=a/(2tan(τ)); and
n=L−a/(2tan(τ)).
The following calculations reveal the value for b*:
tan(τ)=b*/[2(L−a/(2tan(τ)))]; so
b*=tan(T)[2(L−a/(2tan(τ)))].
Where (b*)=(b) (within a predetermined tolerance), pens responsible for forming objects 318 and 320 are aligned along the second axis. Where (b*)<(b) (beyond a predetermined tolerance) those pens are misaligned and underlap along the second axis. Where (b*)>(b) (beyond a predetermined tolerance) those pens are misaligned and overlap along the second axis. The extent to which a pen is misaligned along the second axis can be quantified by the difference between (b) and (b*), if any. A positive valued difference indicates misalignment in one direction along the second axis while a negative valued difference indicates misalignment in an opposite direction.

When a pen is misaligned along the first axis parallel to the print medium's direction of travel as in FIG. 25, there is an additional factor for determining the extent of misalignment along the second axis orthogonal to the first. In FIG. 25, The measured width (B) of object 278 differs from the measured width (A) of object 276 indicating that the pen is also misaligned along the first axis. The distance (E) between objects 276 and 278 appears to exceed an ideal distance (E*) indicating that a pen that formed object 278 is misaligned along the second axis as well. The extent of that misalignment can be quantified as (E*-E)-(B-A)/2.

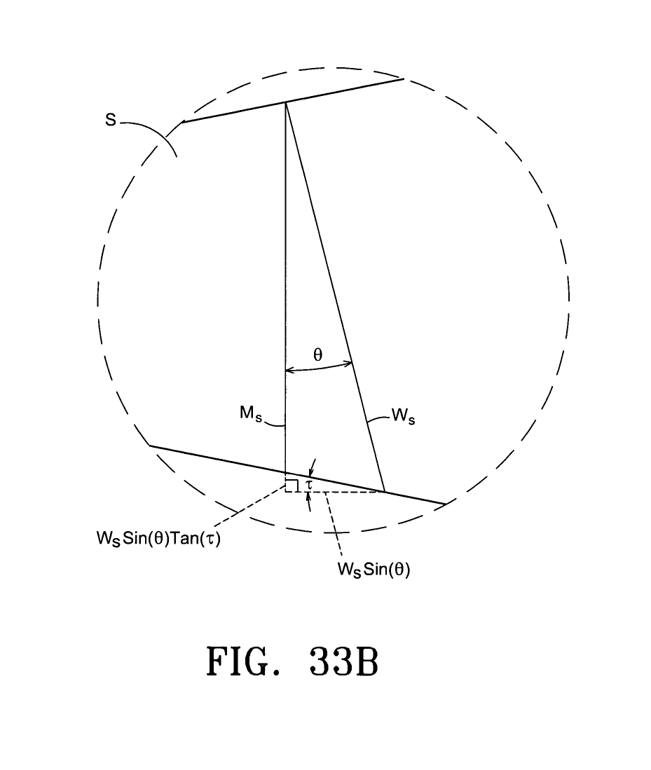

In FIGS. 21-29, the scan lines intersecting the various object patterns were shown as being orthogonal to the direction of print media travel. This will be the case if the print media is stopped while the object pattern is scanned to generate reflectance data. This will also be the approximate case if the print media speed is insignificant relative to the scanner speed. Referring now to FIG. 30, actual scan line 326 deviates from ideal scan line 324. This is because the velocity 328 of the print media at the time of the scan is not insignificant relative to the scan velocity, represented as vector 324.

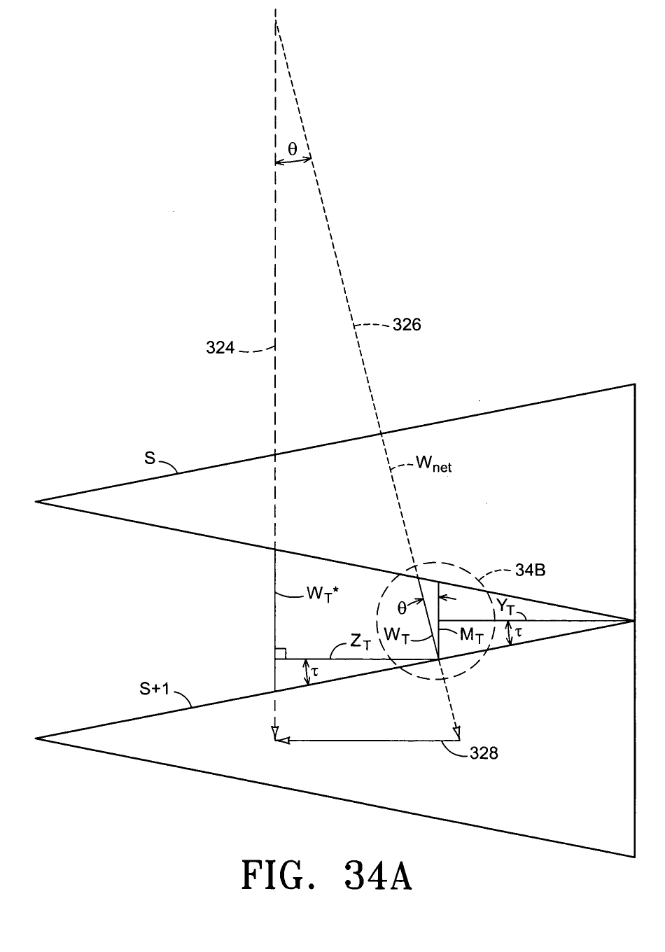

Referring to FIG. 31, triangle objects one, two, three, and four are aligned, meaning that the pens that formed the objects are also aligned. The variables W₁, W₃, W₅, and W₇ represent the measured widths of objects one, two, three, and four along actual scan line 326. The variables W₁*, W₃*, W₅*, and W₇* represent the measured widths of objects one, three, five and seven along ideal scan line 324, or a scan line orthogonal to the direction of media travel. As shown, actual scan line 326 deviates from ideal scan line 324, so W₁<W₃<W₅<W₇. Assuming the differences between the measured values exceed a predetermined tolerance, one could be lead to conclude that objects one, two, three, and four are not aligned along a first axis parallel the velocity of the print media. However, compensating for the deviation reveals that W₁*=W₃*=W₅*=W₇* thus indicating that objects one, two, three, and four are in fact aligned along the first axis.

Referring to FIG. 32, the variables W₂, W₄, and W₆ represent the measured distances between adjacent object pairs along actual scan line 326. W₂ represents the distance between objects one and two. W₄ represents the distance between objects two and three, and W₆ represents the distance between objects three and four. The variables W₂*, W₄*, and W₆* represent the measured distances between adjacent object pairs along ideal scan line 324. W₂>W₄>W₆, leading one to conclude that objects one, two, three and four are not aligned along a second axis orthogonal to the first axis. However, W₂*=W₄*=W₆*, revealing that objects one, two, three, and four are in fact aligned along the second axis.

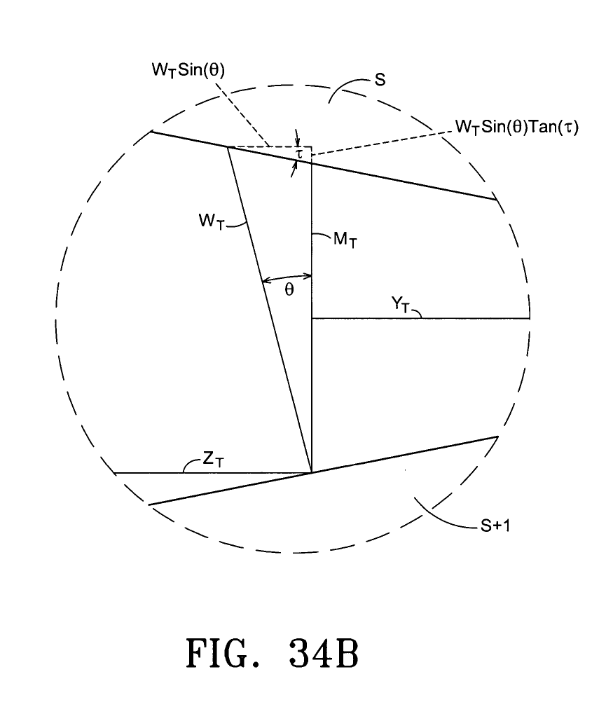

FIGS. 33A, 33B, 34A, and 34B illustrate calculations that can be made to compensate for the deviation between the actual scan line and a scan line orthogonal to the direction of media travel. FIG. 33A illustrates a single object (S). Portion 33B of object (S) is shown in more detail in FIG. 33B. In FIG. 33A, the scan line orthogonal to the direction of media travel is represented by direction arrow 324, while the actual scan line is represented by direction arrow 326. The vector representing the velocity of the print media is represented by direction arrow 328. The goal is to calculate a value of Wₛ* which represents the measured width of object (S) taken along the scan line orthogonal to the direction of media travel 324.

Referring to FIGS. 33A and 33B. there are a number of known values. The value of Wₛ, taken along the actual scan line 326 has been measured. The velocity of the print media (Vₚ) (represented as vector 328) is a design factor of a given image forming device. The velocity of the scanner (Vₛ) (represented as vector 324) is also a known design factor. The angle (τ) is a known design parameter of object (S).

From the known values, a number of variables can be discerned.
θ=tan⁻¹(Vₚ/Vₛ);
Zₛ=WₙₑₜSin(θ); and
Wₙₑₜ=Wₛ₋₁+ . . . +W₁.
Zₛ is a side of the right triangle 329A having angle (θ) and hypotenuse Wₙₑₜ.

The following calculations reveal:
Cos(θ)=(Mₛ+WₛSin(θ)Tan(τ))/Wₛ, so
Mₛ=WₛCos(θ)−WₛSin(θ)Tan(τ).
While:
Tan(τ)=Wₛ*/2Yₛ, so
Wₛ*=2YₛTan(τ).
Also:
Tan(τ)=(Mₛ)/2(Yₛ+Zₛ);
Yₛ+Zₛ=Mₛ/(2Tan(τ)); so
Yₛ=Mₛ/(2Tan(τ))−Zₛ.
Consequently:
Wₛ*=2[M_{s/}(2Tan(τ))−Zₛ]Tan(τ), or
Wₛ*=Mₛ−2ZₛTan(τ).

Using the calculated formulas for Wₛ* and Mₛ with the discernable and known values:
Wₛ*=WₛCos(θ)−WₛSin(θ)Tan(τ)−2ZₛTan(τ).
Inserting the value for Zₛ reveals:
Wₛ*=WₛCos(θ)−WₛSin(θ)Tan(τ)−2WₙₑₜSin(θ)Tan(τ).

FIG. 34A illustrates adjacent object pair (S, S+1). Portion 34B between object pair (S, S+1) is shown in more detail in FIG. 34B. Referring to FIGS. 34A and 34B, the goal is to calculate a value of (W_{T}*) which represents the measured distance between object pair (S, S+1) taken along a scan line orthogonal to the direction of media travel 324. There are a number of known values. The value of (W_{T}), taken along the actual scan line 326 has been measured. The velocity of the print media (Vₚ) is a design factor of a given image forming device. The velocity of the scanner (Vₛ) is also a known design factor. The angle (τ) is a known design parameter of triangle objects S and S+1. From the known values, a number of variables can be discerned.
θ=tan⁻¹(Vₚ/Vₛ);
Z_{T}=WₙₑₜSin(θ); and
Wₙₑₜ=W_{T}+W_{T-1}+ . . . +W₁.
Z_{T} is a side of the right triangle 329B having angle (θ) and hypotenuse Wₙₑₜ

The following calculations reveal:
Cos(θ)=(M_{T}+W_{T}Sin(θ)Tan(τ))/W_{T}, so
M_{T}=W_{T}Cos(θ)−W_{T}Sin(θ)Tan(τ).
While:
Tan(τ)=W_{T}*/2(Y_{T}+Z_{T}), so
W_{T}*=2(Y_{T}+Z_{T})Tan(τ).
Also:
Tan(τ)=(M_{T})/2Y_{T}; so
Y_{T}=M_{T/}(2Tan(τ)).
Consequently:
W_{T}*=2[(M_{T}/(2Tan(τ)))+Z_{T})Tan(τ), or
W_{T}*=M_{T}+2Z_{T}Tan(τ).

Using the calculated formulas for W_{T}* and M_{T} with the discernable and known values:
W_{T}*=W_{T}Cos(θ)−W_{T}Sin(θ)Tan(τ)+2Z_{T}Tan(τ).
Inserting the value for Z_{T} reveals:
W_{T}*=W_{T}Cos(θ)−W_{T}Sin(θ)Tan(τ)+2WₙₑₜSin(θ)Tan(τ).

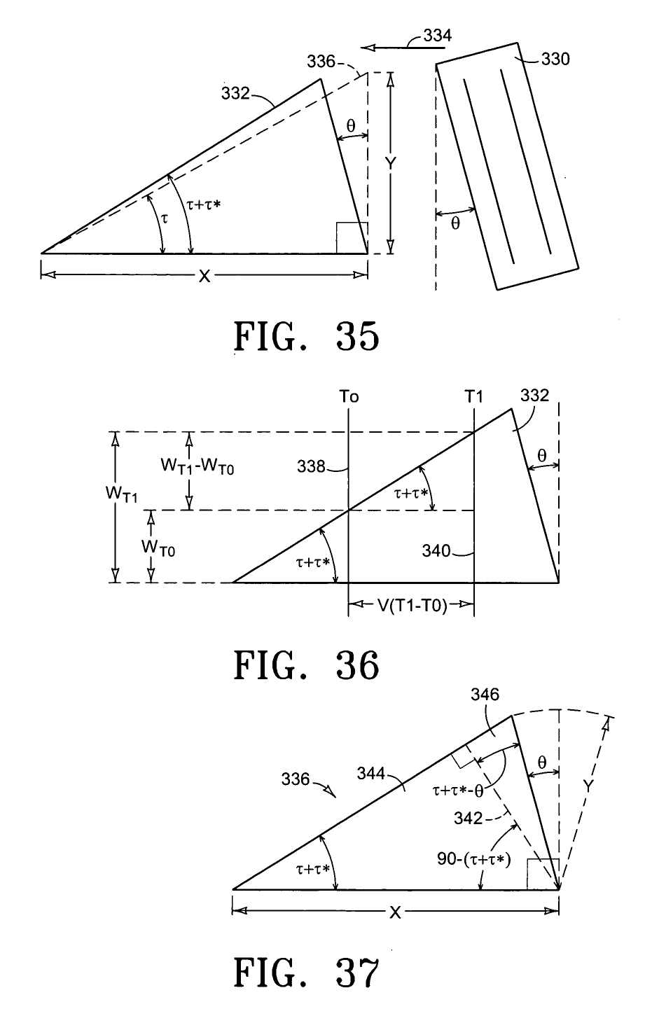

FIGS. 35-37 help to illustrate calculations that can be made to identify a rotational pen misalignment. Referring first to FIG. 35, pen 330 has formed object 332. Arrow 334 indicates the direction of travel of the print medium on which object 332 is formed. As is shown, pen 330 has a rotational offset indicated by the angle (θ). That rotational offset (θ) has caused object 332 to skew from intended object 336.

Intended object 336 is a right triangle having an angle (τ) and dimensions (X) and (Y). Rotational offset (θ) has resulted in object 332 having a skewed angle (τ+τ*). As is shown below, rotational offset (θ) can be calculated as a function of (τ+τ*). The skewed angle (τ+τ*) can be calculated as illustrated in FIG. 36. Line 338 represents a scan line for which reflectance data is obtained at a time (T0). Line 340 represents a scan line for which reflectance data is obtained at a time (T1). Analyzing the reflectance data can reveal width (W_{T0}), the width of object 332 along scan line 338, and (W_{T1}), the width of object 332 along scan line 340. From those, the width (W_{T1}−W_{T0}) can be calculated. Assuming the velocity at which the print medium is traveling to be (V), the distance between scan lines 338 and 340 can be calculated as (V(T1−T0)). The skewed angle (τ+τ*) can then be calculated as Tan⁻¹[(W_{T1}−W_{T0})/{V*(T1−T0)}]

With the value of the skewed angle (τ+τ*) known, the value of rotational offset angle (θ) can be calculated as illustrated in FIG. 37. Object 336 has known dimensions (X) and (Y). Imaginary line 342 splits object 336 into two right triangles. 344 and 346. Triangle 344 includes dimension (X) and skewed angle (τ+τ*). Triangle 346 includes dimension (Y) and angle (τ+τ*−θ). Using triangle 344, the length of line 342 can be calculated as XSin(τ+τ*). Using triangle 346, the length of line 342 can be calculated as YCos(τ+τ*−θ). Therefore:
YCos(τ+τ*−θ)=XSin(τ+τ*);
Cos(τ+τ*−θ)=XSin(τ+τ*)/Y;
(τ+τ*−θ)=Cos⁻¹(XSin(τ+τ*)/Y); so
θ=τ+τ*−Cos⁻¹(XSin(τ+τ*)/Y).
The value of the skewed angle (τ+τ*) calculated above can then be used to determine the rotational offset angle (θ).

An example of steps taken to determine if a pen is misaligned by a rotational offset angle (θ) can be summarized as follows. The pen is used to form an object that has a width dimension that varies according to that object's position along a first axis that is parallel to a direction of travel of the print medium. First reflectance data corresponding to a first scan line that intersects the object at a first time is obtained as is second reflectance data corresponding to a second scan line that intersects the object at a second time. The first and second reflectance data are analyzed to identify a skewed angle. In the example above, a skewed angle exists where (τ+τ*) differs from a (τ) by more than a predetermined tolerance. The rotational offset of the pen can be calculated a function of the skewed angle.

### Conclusion

The block diagram of FIG. 6 and the corresponding schematic illustration of FIG. 7 show the architecture, functionality, and operation of an exemplary environment in which various embodiments of the present invention may be implemented. The block diagram of FIG. 8 illustrates an example of the logical components that can be used to implement the various embodiments. Each block in FIG. 8 may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable medium for use by or in connection with an instruction execution system such as a computer/processor based system or an ASIC (Application Specific Integrated Circuit) or other system that can fetch or obtain the logic from computer-readable media and execute the instructions contained therein. “Computer-readable medium” can be any of one or more computer readable media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow charts of FIGS. 9-13 show a specific orders of execution, the orders of execution may differ from those depicted. For example, the order of execution of two or more blocks may be scrambled relative to the order shown. Also, two or more blocks shown in succession may be executed concurrently or with partial concurrence. All such variations are within the scope of the present invention.

Embodiments of the present invention have been shown and described with reference to the foregoing exemplary implementations. It is to be understood, however, that other forms, details, and embodiments may be made without departing from the spirit and scope of the invention which is defined in the following claims.

1. A method for evaluating an image forming device, comprising:
forming an object on a print medium;
scanning a light beam along a scan line that intersects the object;
obtaining reflectance data corresponding to the scan line; and
evaluating the image forming device according to the reflectance data.

2. The method of claim 1, wherein:
forming comprises forming an object that has a width dimension that varies along a first axis that is parallel to a direction of travel of the print medium;
obtaining comprises obtaining first reflectance data corresponding to a first scan line that intersects the object at a first time and obtaining second reflectance data corresponding to a second scan line that intersects the object at a second time; and
evaluating comprises analyzing the first and second reflectance data to identify a velocity of the print media.

3. The method of claim 1, wherein:
forming comprises forming an object that has a width dimension that varies along a first axis that is parallel to a direction of travel of the print medium;
obtaining comprises obtaining first reflectance data corresponding to a first scan line that intersects the object at a first time and obtaining second reflectance data corresponding to a second scan line that intersects the object at a second time; and
evaluating comprises analyzing the first and second reflectance data to determine a rotational offset of a pen used to form the object.

4. The method of claim 1, wherein evaluating includes analyzing the reflectance data for an object gap.

5. The method of claim 4, wherein forming includes a pen forming the object on the print medium, the pen having a plurality of nozzles, and wherein analyzing includes recognizing a nozzle misfire upon identifying the existence of an object gap.

6. The method of claim 1, wherein:
forming an object comprises forming an object pattern on the print medium; and
obtaining includes obtaining reflectance data corresponding to a scan line that intersects the object pattern.

7. The method of claim 6, wherein evaluating includes analyzing the reflectance data corresponding to an adjacent object pair and recognizing a pen misalignment where the analysis reveals an underlap or an overlap.

8. The method of claim 7, wherein evaluating includes quantifying the misalignment according the extent of underlap or overlap.

9. The method of claim 6, wherein evaluating includes analyzing the reflectance data to measure a width of each object and comparing the measured widths to evaluate pen alignment.

10. The method of claim 9, wherein a motion of the print medium causes the scan line to deviate, the method further comprising adjusting the measured widths to compensate for the deviation.

11. The method of claim 9, wherein evaluating comprises determining whether a pen is aligned based on whether a measured width of a particular object is less than or greater than the measured width of another object.

12. The method of claim 11, wherein evaluating includes calculating a difference between a first measured width of an object and a second measured width of another object and quantifying a misalignment according to the difference.

13. The method of claim 6, wherein;
each object is formed at least in part by a different pen and each object has a width dimension that varies along a first axis that is parallel to a direction of travel of the print medium; and
evaluating comprises analyzing the reflectance data to measure a distance between each pair of adjacent objects and examining the measured distances to determine if the pens are aligned along a second axis orthogonal to the print medium's direction of travel.

14. The method of claim 13, wherein a motion of the print medium causes the scan line to deviate, the method further comprising adjusting the measured widths and the measured distances to compensate for the deviation.

15. The method of claim 13, wherein evaluating includes:
calculating a distance between an adjacent object pair as a function of a measured width of an object; and
comparing the measured distance between the adjacent object pairs with the calculated distance.

16. The method of claim 15, wherein evaluating includes quantifying a misalignment according to a difference between the measured distance and the calculated distance.

17. A computer readable medium having instructions for:
causing a formation of an object on a print medium;
causing a light beam to be scanned along a scan line that intersects the object;
obtaining reflectance data corresponding to the scan line; and
evaluating an image forming device according to the reflectance data.

18. The medium of claim 17, wherein the instructions for:
causing include instructions for causing the formation of an object that has a width dimension that varies according to that object's position along a first axis that is parallel to a direction of travel of the print medium;
obtaining include instructions for obtaining first reflectance data corresponding to a first scan line that intersects the object at a first time and obtaining second reflectance data corresponding to a second scan line that intersects the object at a second time; and
evaluating include instructions for analyzing the first and second reflectance data to identify a velocity of the print media.

19. The medium of claim 17, wherein the instructions for:
forming include instructions for forming an object that has a width dimension that varies along a first axis that is parallel to a direction of travel of the print medium;
obtaining include instructions for obtaining first reflectance data corresponding to a first scan line that intersects the object at a first time and obtaining second reflectance data corresponding to a second scan line that intersects the object at a second time; and
evaluating includes analyzing the first and second reflectance data to determine a rotational offset of a pen used to form the object.

20. The medium of claim 17, wherein the instructions for evaluating include instructions for analyzing the reflectance data for an object gap.

21. The medium of claim 17, wherein the instructions for:
causing include instructions for causing a pen to form the object on the print medium; and
analyzing include instructions for recognizing a nozzle misfire upon identifying the existence of an object gap.

22. The medium of claim 17, wherein the instructions for:
causing include instructions for causing the formation of an object pattern; and
obtaining include instructions for obtaining reflectance data corresponding to a scan line that intersects the object pattern.

23. The medium of claim 22, wherein the instructions for:
causing include instructions for causing an array of pens to form the object patterns; and
evaluating include instructions for analyzing the reflectance data for an adjacent object pair and recognizing a pen misalignment where the analysis reveals an underlap or an overlap.

24. The medium of claim 23, wherein the instructions for evaluating include instructions for quantifying the misalignment according an extent of underlap or overlap.

25. The medium of claim 22, wherein the instructions for evaluating include instructions for analyzing the reflectance data to measure a width of each object and comparing the measured widths to evaluate pen alignment.

26. The medium of claim 25, wherein a motion of the print medium causes the scan line to deviate, and wherein the instructions for evaluating include instructions for adjusting the measured widths to compensate for the deviation.

27. The medium of claim 25, wherein the instructions for evaluating include instructions for determining whether a pen is aligned base on whether a measured width of a particular object is less than or greater than the measured width of another object.

28. The medium of claim 27, wherein the instructions for evaluating include instructions for calculating a difference between a first measured width of an object and a second measured width of another object and quantifying a misalignment according to the difference.

29. The medium of claim 23, wherein:
the instructions for causing include instructions for causing the array of pens to form the object pattern on the print medium, wherein each object is formed at least in part by a different pen and each object has a width dimension that varies along a first axis that is parallel to a direction of travel of the print medium; and
the instructions for evaluating include instructions for analyzing the reflectance data to measure, along the scan line, a distance between each pair of adjacent objects and examining the measured distances to determine if the pens are aligned along a second axis orthogonal to the print medium's direction of travel.

30. The medium of claim 29, wherein a motion of the print medium causes the scan line to deviate, and wherein the instructions for evaluating include instructions for adjusting the measured widths and the measured distances to compensate for the deviation.

31. The medium of claim 29, wherein the instructions for evaluating include instructions for:
calculating a distance between an adjacent object pair as a function of a measured width of an object; and
comparing the measured distance between the adjacent object pairs with the calculated distance.

32. The medium of claim 31 wherein evaluating includes quantifying a misalignment according to a difference between the calculated distance and the measured distance.

33. A system for evaluating an image forming device, comprising:
a computer readable medium storing printing logic, scanner logic, and evaluation logic; and
a processor operable to execute the printing logic, scanner logic, and evaluation logic;
wherein, when executed by the processor:
the printing logic is operable to cause the formation of an object on a print medium;
the scanner logic is operable to cause a light beam to be scanned along a scan line that intersects the object and to obtain reflectance data corresponding to the scan line; and
the evaluation logic is operable evaluate an image forming 13 device status according to the reflectance data.

34. The system of claim 33, wherein, when executed by the processor:
the printing logic is operable to cause the formation of an object that has a width dimension that varies along a first axis that is parallel to a direction of travel of the print medium;
the scanner logic is operable to obtain first reflectance data corresponding to a first scan line that intersects the object at a first time and to obtain second reflectance data corresponding to a second scan line that intersects the object at a second time; and
the evaluation logic is operable to analyze the first and second reflectance data to identify a velocity of the print media.

35. The system of claim 33, wherein, when executed by the processor:
the printing logic is operable to cause the formation of an object that has a width dimension that varies along a first axis that is parallel to a direction of travel of the print medium;
the scanner logic is operable to obtain first reflectance data corresponding to a first scan line that intersects the object at a first time and to obtain second reflectance data corresponding to a second scan line that intersects the object at a second time; and
the evaluation logic is operable to analyze the first and second reflectance data to determine a rotational offset of a pen used to form the object.

36. The system of claim 33, wherein, when executed by the processor:
the printing logic is operable to cause a pen to form the object; and
the evaluation logic is operable to recognize a nozzle misfire by analyzing the reflectance data for an object gap.

37. The system of claim 33, wherein, when executed by the processor:
the printing logic is operable to direct an array of pens to form an object pattern on the print medium; and
the scanner logic is operable to obtain reflectance data corresponding to a scan line that intersects the object pattern.

38. The system of claim 37, wherein the evaluation logic, when executed by the processor, is operable to analyze the reflectance data corresponding to an adjacent object pair and recognize a pen misalignment where the analysis reveals an underlap or an overlap.

39. The system of claim 37, wherein the evaluation logic, when executed by the processor, is operable to analyze the reflectance data to measure a width of each object and to compare the measured widths to evaluate pen alignment.

40. The system of claim 39, wherein a motion of the print medium causes the scan line to deviate, and wherein the evaluation logic, when executed by the processor, is operable to adjust the measured widths to compensate for the deviation.

41. The system of claim 37, wherein, when executed by the processor:
the printing logic is operable to direct the array of pens to form the object pattern such that each object is formed at least in part by a different pen and each object has a width dimension that varies along a first axis that is parallel to a direction of travel of the print medium; and
the evaluation logic is operable to analyze the reflectance data to measure a distance between each pair of adjacent objects and to examine the measured distances to determine if the pens are aligned along a second axis orthogonal to the print medium's di rection of travel.

42. The system of claim 41, wherein a motion of the print medium causes the scan line to deviate, and wherein the evaluation logic, when executed by the processor, is operable to adjust the measured distances to compensate for the deviation.

43. An image forming device, comprising:
a print engine operable to form a desired image on a print medium;
a scanner operable to scan a light beam along a scan line and to generate corresponding reflectance data;
a processor;
printing logic, that when executed by the processor, is operable to direct the print engine to form an object on the print medium;
scanner logic that, when executed by the processor, is operable to direct the scanner to scan a light beam along a scan line that intersects the object and to obtain reflectance data corresponding to the scan line;
evaluation logic that, when executed by the processor, is operable to evaluate the image forming device according to the reflectance data.

44. The image forming device of claim 43, wherein, when executed by the processor:
the printing logic is operable to cause the formation of an object that has a width dimension that varies along a first axis that is parallel to a direction of travel of the print medium;
the scanner logic is operable to obtain first reflectance data corresponding to a first scan line that intersects the object at a first time and to obtain second reflectance data corresponding to a second scan line that intersects the object at a second time; and
the evaluation logic is operable to analyze the first and second reflectance data to identify a velocity of the print media.

45. The image forming device of claim 43, wherein, when executed by the processor:
the printing logic is operable to cause the formation of an object that has a width dimension that varies along a first axis that is parallel to a direction of travel of the print medium;
the scanner logic is operable to obtain first reflectance data corresponding to a first scan line that intersects the object at a first time and to obtain second reflectance data corresponding to a second scan line that intersects the object at a second time; and
the evaluation logic is operable to analyze the first and second reflectance data to determine a rotational offset of a pen used to form the object.

46. The image forming device of claim 43, wherein the print engine includes a pen having a plurality of nozzles and the evaluation logic, when executed by the processor, is operable to recognize a nozzle misfire by analyzing the reflectance data for an object gap.

47. The image forming device of claim 43, wherein:
the print engine includes an array of pens;
the printing logic, when executed by the processor, is operable to direct the array of pens to form an object pattern on the print medium; and
the scanner logic, when executed by the processor, is operable to obtain reflectance data corresponding to a scan line that intersects the object pattern.

48. The image forming device of claim 47, wherein the evaluation logic, when executed by the processor, is operable to analyze the reflectance data corresponding to an adjacent object pair and recognize a pen misalignment where the analysis reveals an underlap or an overlap.

49. The image forming device of claim 47, wherein the evaluation logic, when executed by the processor, is operable to analyze the reflectance data to measure a width of each object and to compare the measured widths to evaluate pen alignment.

50. The image forming device of claim 49, wherein a motion of the print medium causes the scan line to deviate, and wherein the evaluation logic, when executed by the processor, is operable to adjust the measured widths to compensate for the deviation.

51. The image forming device of claim 47, wherein when executed by the processor:
the printing logic is operable to direct the array of pens to form the object pattern such that each object is formed at least in part by a different pen and each object has a width dimension that varies along a first axis that is parallel to a direction of travel of the print medium; and
the evaluation logic is operable to analyze the reflectance data to measure a distance between each pair of adjacent objects and to examine the measured distances to determine if the pens are aligned along a second axis orthogonal to the print medium's di rection of travel.

52. The image forming device of claim 51, wherein a motion of the print medium causes the scan line to deviate, and wherein the evaluation logic, when executed by the processor, is operable to adjust the measured distances to compensate for the deviation.

53. A system for evaluating pen status, comprising:
a means for forming an object on a print medium;
a means for scanning a light beam along a scan line that intersects the object;
a means for obtaining reflectance data corresponding to the scan line; and
a means for evaluating an image forming device status according to the reflectance data.

54. An image forming device, comprising:
a print engine operable to form a desired image on a print medium;
a scanner operable to scan a light beam along a scan line and to generate reflectance data corresponding to the scan line;
a means for directing the print engine to form an object on the print medium;
a means for directing the scanner to generate reflectance data corresponding to a scan line that intersects the object; and
a means for evaluating a status of the image forming device according to the reflectance data.
